(19) United States
(12) Patent Application Publication
(10) Pub. No.: US 2003/0047709 A1
(43) Pub. Date: Mar. 13, 2003

(54) Monoepoxycyclohexyl carboxylates and aircraft hydraulic fluids containing same

(76) Inventor: Marc-Andre Poirier, Cherry Hill, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 10/081,322

(22) Filed: Feb. 22, 2002

Related U.S. Application Data
(60) Provisional application No. 60/285,108, filed on Apr. 20, 2001.

(51) Int. Cl. C09K 5/00

(52) U.S. Cl. 252/78.5

(57) ABSTRACT

Functional fluids employing organic phosphate ester basestocks and mono-epoxide acid scavengers have improved EPR seal compatibility by using as the acid scavengers a mono-epoxide having the formula

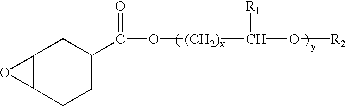

where R₁ is H or a C₁ to C₄ alkyl; x is an integer of 1 to 2; y is an integer of 1 to 4; and R₂ is a C₁ to C₄ alkyl group or a phenyl group.

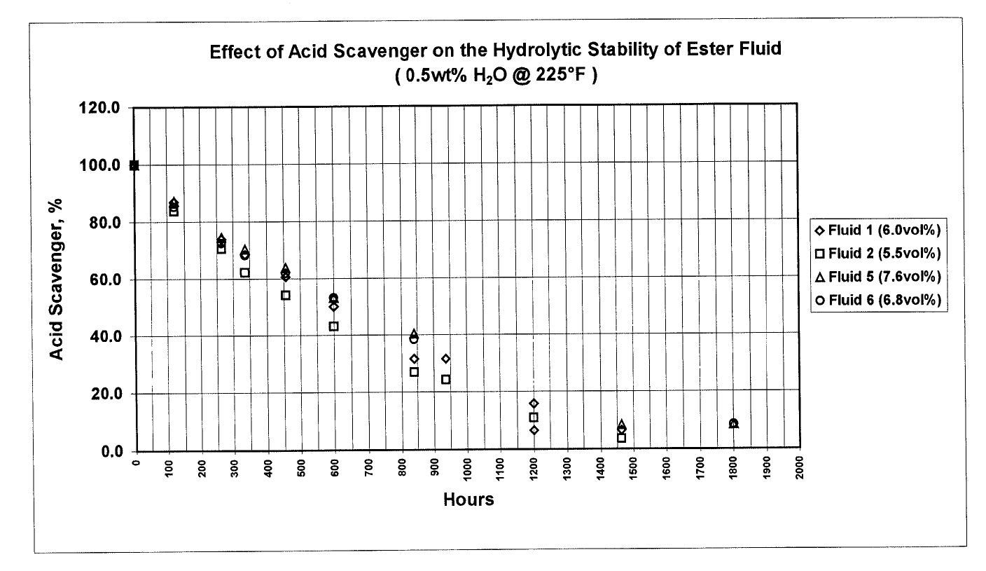

### FIELD OF INVENTION

This invention relates to monoepoxycyclohexyl carboxylates and functional fluid compositions containing them which have hydrolytic stability and improved elastomer compatibility. More particularly the invention relates to phosphate ester functional fluids containing certain monoepoxycyclohexyl carboxylates in amounts sufficient to improve the fluids hydrolytic stability and elastomer compatibility.

### BACKGROUND OF INVENTION

Functional fluids are used in a wide variety of industrial applications. For example they are used as the power transmitting medium in hydraulic systems, such as aircraft hydraulic systems.

Functional fluids intended for use in aircraft hydraulic systems must meet stringent performance criteria such as thermal stability, fire resistance, low susceptibility to viscosity changes over a wide range of temperatures, good hydrolytic stability, elastomer compatibility and good lubricity.

Organic phosphate ester fluids have been recognized as a preferred fluid for use as a functional fluid such as in aircraft hydraulic fluids. Indeed, in present commercial aircraft hydraulic fluids phosphate esters are among the most commonly used base stocks.

It is known that the presence of water in phosphate ester based hydraulic fluids can result in the hydrolysis of the phosphate esters which produces corrosion and other undesirable effects. Thus, various acid scavengers have been used in these functional fluids to inhibit acid buildup in the fluid and its detrimental effects thereby extending the useful life of the fluid. Epoxy compounds represent one class of compounds among the many acid scavengers in functional fluids.

EP 0 520 419 A2 discloses the cycloaddition of dienes with dienophillis (meth/eth) acrylates to yield unsaturated cycloaliphatic esters and their derivatives including monoepoxides. A wide range of potential uses for these compounds are suggested including use as acid scavengers.

In WO 96/17517, for example, a hydraulic fluid is disclosed which contains among other ingredients an acid scavenger of formula I:

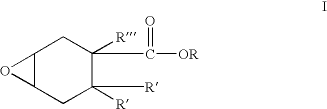

where R is selected from the group consisting of an alkyl group of from 1 to 10 carbon atoms optionally containing from 1 to 4 ether oxygen atoms therein and cycloalkyl of from 3 to 10 carbon atoms, each R′ is independently selected form the group consisting of hydrogen, alkyl of from 1 to 10 carbon atoms, and —C(O)OR ″ where R″ is alkyl of from 1 to 10 carbon atoms optionally containing from 1 to 4 ether oxygen atoms therein or cycloalkyl of from 3 to 10 carbon atoms, and R′″ is selected from the group consisting of hydrogen, alkyl of from 1 to 10 carbon atoms and —C(O)OR″ where R″ is alkyl of from 1 to 10 carbon atoms optionally containing from 1 to 4 ether oxygen atoms therein or cycloalkyl of from 3 to 10 carbon atoms.

Although many epoxy compounds may be used in functional fluids as acid scavengers experience has shown that there is a wide variability in performance of the various epoxides. This variability in performance often necessitates use of a greater amount of one epoxide to obtain substantially the same performance characteristics obtained with another epoxide. In aircraft hydraulic fluids, as with most functional fluids use of lesser amounts of additives is extremely desirable. Also, determining the proper acid scavenger for a hydraulic fluid formulation is not readily predictable. For example, a combination of additives in one basestock may not perform nearly as well in another basestock. Additionally, the inclusion of an additional additive into a hydraulic fluid formulation can deleteriously affect the performance of one or more of the additives already employed in that formulation.

### SUMMARY OF INVENTION

In the present invention a hydraulic fluid having an organic phosphate ester basestock and a mono epoxide acid scavenger is improved by using as the acid scavenger an epoxide of the formula II:

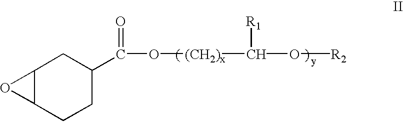

where R₁ is H or a C₁ to C₄ alkyl; x is an integer of 1 to 2; y is an integer of 1 to 4; and R₂ is a C₁ to C₄ alkyl group or a phenyl group.

The improvement comprises achieving hydrolytic stability of the basestock and EPR seal compatibility at lower loadings than with other mono epoxides especially compared with mono epoxides that do not contain alkoxy groups. The improvement further comprises achieving reduced EPR seal swelling by using lesser amounts of the acid scavenger of this invention than required for prior art epoxides.

In another embodiment a novel compound is disclosed having the formula II above wherein R₁ is H or C₁ to C₄ alkyl; x is 1 or 2; 4 is 2 or more; and R₂ is a C₁ to C₄ alkyl group or phenyl group. In a particularly preferred embodiment R₁ is H; x is 1, y is 2; and R₂ is a C₂ alkyl group.

### BRIEF DESCRIPTION OF THE DRAWING

The accompanying figure is a graph comparing the effect of an acid scavenger of this invention with one of the prior art on hydrolytic stability of phosphate ester fluid.

### DETAILED DESCRIPTION OF THE INVENTION

It has been discovered that hydraulic fluids having an organic ester basestock can be enhanced by incorporating in the basestock from about 1 to about 10 wt % based on the basestock of an acid scavenger having formula II:

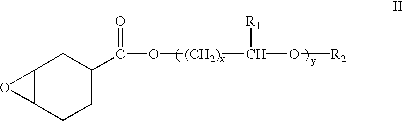

where R₁ is H or a C₁ to C₄ alkyl; x is an integer of 1 to 2; y is an integer of 1 to 4; and R₂ is a C₁ to C₄ alkyl group or a phenyl group.

Preferred compounds represented by Formula II include those in which x is 1 and y is 2, R₁ is H, and R₂ is methyl or ethyl; those in which x is 1 and y is 2, R₁ is H, and R₂ is methyl or ethyl; especially ethoxy and R₂ is ethyl. Preferably x is 1, y is 2, R₁ is H, and R₂ is ethyl. Indeed those compounds represented by formula II in which y is 2 or more, especially 2 to 4, comprise novel compounds and another embodiment of the invention.

Acid scavengers of Formula II may be prepared by the general procedure described in EP 0 520 419 A2 which is incorporated herein by reference. Basically, the procedure involves reacting the appropriate alkoxylacrylate with 1,3-butadiene to form an unsaturated cycloaliphatic ester. The unsaturated cycloaliphatic ester then converted to the epoxide by oxidation of the olefinic bonds by use of a peroxide such as peracetic or m-chloroperbenzoic acid.

An alternate method for forming compounds of Formula II comprises esterifying 3-cyclohexene-1-carboxylic acid with an alkoxyl alcohol and there-after converting the unsaturated cycloaliphatic ester to the expoxide as described above.

The above acid scavengers are useful in enhancing the performance, i.e., hydrolytic stability and EPR seal compatibility of organic phosphate ester basestocks.

Phosphate ester base stocks used in this invention refer to organo-phosphate esters selected from trialkyl phosphate, dialkyl aryl phosphate, alkyl diaryl phosphate, triaryl phosphate and alkylated triaryl phosphate that contain from 3 to 8, preferably from 4 to 5 carbon atoms in the alkyl group. Preferably the aryl group is phenyl and the alkylated group of the alkylated triaryl phosphate is isopropyl, n-butyl or tert-butyl. Suitable phosphate esters useful in the present invention include, for example, tri-n-butyl phosphate, tri-isobutyl phosphate, n-butyl di-isobutyl phosphate, di-isobutyl n-butyl phosphate, n-butyl diphenyl phosphate, isobutyl diphenyl phosphate, di-n-butyl phenyl phosphate, di-isobutyl phenyl phosphate, tri-n-pentyl phosphate, tri-isopentyl phosphate, triphenyl phosphate, isopropylated triphenyl phosphates, and butylated triphenyl phosphates, preferably, the trialkyl phosphate esters are those of tri-n-butyl phosphate and tri-isobutyl phosphate.

The amounts of each type of phosphate ester in the hydraulic fluid can vary depending upon the type of phosphate ester involved. The amount of trialkyl phosphate in the base stock fluid comprises from about 10 wt % to about 100 wt % preferably from about 20 wt % to about 90 wt %. The amount of dialkyl aryl phosphate in the base stock fluid is typically from 0 wt % to 75 wt % prefer-ably from 0 wt % to about 50 wt %. The amount of alkyl diaryl phosphate in the base stock fluid is typically from 0 wt % to 30 wt %, preferably from 0 wt % to 10 wt %. The amount of triaryl phosphate in the base stock fluid is typically from 0 wt % to 20 wt % and preferably from 0 wt % to 15 wt %. The amount of alkylated triaryl phosphate is typically from 0 wt % to about 20 wt % of the base stock fluid.

Unexpectedly, it has been discovered that on a volume basis the acid scavengers of this invention, i.e., of formula II have better hydrolytic stability and improved EPR seal compatibility when compared to the acid scavenger of formula III.

The phosphate ester based hydraulic fluids of the invention may also contain from 1 to 20 wt % based on the total weight of the fluid composition of other additives selected from one or more of antioxidants, VI improvers, rust inhibitors, defoamers and the like.

Antioxidants useful in hydraulic fluid compositions include, for example, polyphenols, trialkylphenols and di (alkylphenyl) amines such as bis (3,5-di-tert-butyl-4-hydroxyphenyl) methane, 1,3,5-trimethyl-2,4,6-tris (3,5-di-tert-butyl-4-hydroxyphenyl) benzene and 2,6-di-tert-butyl-4-methylphenol (BHT) to tetrakis (methylene (3,5-di-tert-butyl-4-hydroxyhydrocinnamate) di-(n-octylphenyl) amine, all commercially available. Typical amounts for each type of antioxidants can be from about 0.1 wt % to 2 wt %.

Anti-erosion additives useful in hydraulic fluid compositions of this invention include alkali metal salts of perfluoroalkylsulfonic acids such as potassium perfluorooctyl sulfonate. Typical amounts of anti-erosion additives used in hydraulic fluid compositions can be from about 0.01 wt % to about 0.1 wt %.

Viscosity Index Improver (VII) additives useful in hydraulic fluid compositions include polyacrylate esters and poly (alkyl methacrylate) esters of the type described in U.S. Pat. No. 5,817,606. Typically, the viscosity index improver is of high molecular weight, having a number average molecular weight between about 50,000 and about 100,000 and a weight average molecular weight between about 200,000 and 350,000. The hydraulic fluid compositions of this invention can contain from about 3 wt % to about 10 wt % of the viscosity index improver.

In addition to the above additives, other additives may be added to the hydraulic fluid compositions. These include metal corrosion inhibitors such as benzotriole derivatives and dihydroimidazole derivatives. These corrosion inhibitors may be added to the hydraulic fluid composition at levels from about 0.01 wt % to 0.5 wt %. Anti-foaming additives such as polyalkylsiloxane fluids can be used at levels from about 0.005 wt % to about 0.01 wt %.

### EXAMPLE 1

### Preparation of 2-(2-ethoxyethoxy) ethyl-3-cyclohexene carboxylate

In a 3-liter round bottom flask equipped with a magnetic bar, a Dean-Stark, a condenser and a heating mantle, was placed 1400 ml of dry toluene, 433.8 g (3.44 mole) of 3-cyclohexene-l-carboxylic acid, 481.5 (3.59 mole) of diethylene glycol monoethyl ether and about 400 mg of p-toluenesulfonic acid. The mixture was refluxed for about 34 hours until about 60 ml of water was collected. The reaction mixture was transferred into a 4-L separatory funnel to which 750 ml of ether was added. The organic layer was washed twice with 700 ml 2% sodium hydroxide solution followed by 4×700 ml of water. The organic layer was dried over anhydrous sodium sulfate. The toluene evaporated under vacuum to yield 759 g of product (91% yield).

### EXAMPLE2

### Preparation of 2-(2-ethoxyethoxyl) ethyl 7-oxabicyclo [4.1.0] heptane-3-carboxylate

To an ice-cold mechanically stirred 3-necked (2-L) round bottom flask containing 64.8 g (0.268 mole) of 2-(2-ethoxyethoxy) ethyl-3-cyclohexene carboxylate and 84.8 g (0.8 mole) anhydrous sodium carbonate in 1400 ml methylene chloride was added dropwise 63.8 g of 32% peracetic acid at a rate so the reaction temperature was kept below 7° C. The reaction was followed by gas chromatography. After 18 hours if unreacted olefin was detected, more peracetic acid was added (20% excess). The solid salt was removed by filtration under vacuum through a glass funnel plugged with cotton wool. The reaction mixture was then poured into a 2-L separatory funnel and washed with 2% sodium hydroxide solution followed by water until pH 7 was obtained. The organic layer was tested for peroxides with a potassium iodide solution. The organic layer was drawn off and dried over magnesium sulfate. The removal of the solvent under vacuum gave 62.1 g of epoxide (90% yield).

### EXAMPLE 3

### Preparation of 2-(2-ethoxyethoxy) ethyl 7-oxabicyclo [4.1.0] heptane-3-carboxylate

m-Chloroperbenzoic acid (58.2 g, maximum content 77%, Aldrich) was added in 10 portions to the cold (ice bath) solution of 2-(2-ethoxyethoxy) ethyl 3-cyclohexene-1-carboxylate (48.4 g, 0.2 mole) in 500 ml chloroform. The reaction mixture was stirred with a mechanical stirrer for 2 hours then the ice bath was removed and stirring was continued for additional 2 hours. The reaction mixture was cooled down with an ice bath and the excess of peroxide was quenched by dropwise addition of 250 ml saturated sodium sulfite solution. The ice bath was removed and the reaction mixture was warmed up to room temperature. The organic layer was separated in a separatory funnel and washed sequentially with saturated sodium bicarbonate (5×100 ml) and water (2×100 ml). The organic layer was dried over magnesium sulfate and the solvent removed under vacuum. The product was distilled under vacuum (170-175° C., 9 mm Hg) to yield 88% of the product.

### EXAMPLE 4

This example compares the physical properties of a compound of Formula II in which R₁ is H, R₂ is —C₂H₅, x=1 and y=2 hereinafter “A-1” with a compound of formula III where R is 2-ethylhexyl, herein after “B-1” (see Table 1).

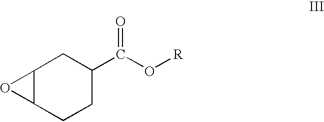

TABLE 1

| Properties | A-1 | B-1 |
|---|---|---|
| Molecular Formula | C₁₃H₂₂O₅ | C₁₅H₂₆O₃ |
| Molecular Weight | 258 | 254 |
| % Oxygen | 31.0 | 18.9 |
| Density, g/ml | 1.0973 | 0.993 |
| Vol % for 100% Epoxide | 5.47 | 6.04 |

The data show that to obtain the desired epoxide content in the fluids on a volume basis 100 g of hydraulic fluid would require 5.47 ml of A-1 and 6.04 ml of B-1 to obtain the same epoxide content.

### EXAMPLE 5

A series of fluids were prepared having the composition shown in Table 2. In each of the compositions the same additive package was used.

TABLE 2

| Component, | | | | | | |
|---|---|---|---|---|---|---|
| wt % | Fluid 1 | Fluid 2 | Fluid 3 | Fluid 4 | Fluid 5 | Fluid 6 |
| Base Oil | | | | | | |
| tributyl | 66.6416 | 66.6416 | 62.6416 | 62.6416 | 65.1416 | 65.1416 |
| phosphate | | | | | | |
| triaryl | 11.8 | 11.8 | 11.8 | 11.8 | 11.8 | 11.8 |
| phosphate | | | | | | |
| Acid Scavenger | | | | | | |
| A-1 (see | | 6.0 | | 10.0 | | 7.5 |
| Example 4) | | | | | | |
| B-1 (see | 6.0 | | 10.0 | | 7.5 | |
| Example 4) | | | | | | |
| Additives | | | | | | |
| defoamers, rust | balance | balance | balance | balance | balance | balance |
| inhibitor, etc. | | | | | | |

The low temperature properties of the first four fluids of Table 2 are compared in Table 3.

TABLE 3

| Properties | Fluid 1 | Fluid 2 | Fluid 3 | Fluid 4 |
|---|---|---|---|---|
| Density @ 25° C., 9 ml | .9934 | .9992 | .9939 | 1.0036 |
| Specific gravity @ 25° C./25° C. | .9963 | 1.0021 | .9968 | 1.0065 |
| Viscosity @ −65° F., cSt | 1271 | 1270 | 1491 | 1521 |
| Viscosity @ 100° F., cSt | 10.40 | 10.27 | 10.78 | 10.90 |
| Acid number, mg KOH/gm | 0.09 | 0.09 | 0.09 | 0.09 |
| Epoxide vol % (for 100%) | 6.04 | 5.47 | 10.07 | 9.11 |

This example shows that the addition of the epoxide of formula II of this invention to a polyester based hydraulic fluid provides good low temperature viscosity.

### EXAMPLE 6

The hydrolytic stability of Fluids 1, 2, 5 and 6 were tested by placing samples of the fluids in an ampoule with about 0.5 wt % water and a piece of copper and stainless steel wire. The ampoules were sealed and kept in a heated oven (225° F.). At various time intervals the acid number of a sample was determined. The results are shown in the accompanying figure.

This example illustrates that the fluid containing the A-1 (Fluid 2 and Fluid 6) acid scavenger of Example 4 has a better hydrolytic stability than the fluid containing the B-1 (Fluid 1 and Fluid 5 acid scavenger of Example 4). The repeatability of the acid scavenger determination test method being about ±6.0%, there is no significant difference between the two first tests (6.0 vol % and 5.5 vol %) and the two last tests (7.6 vol % and 6.8 vol %).

### EXAMPLE 7

The elastomer compatibility of Fluids 1 to 4 was determined by immersing EPR samples in the fluids for 70 hours at 160° F. and thereafter measuring the elastomer properties shown in Table 4.

TABLE 4

| Properties | Fluid 1 | Fluid 2 | Fluid 3 | Fluid 4 |
|---|---|---|---|---|
| Elastomer compatibility | | | | |
| 70 hours @ 160° F. | | | | |
| Volume swell, % | 8.50 | 6.57 | 9.23 | 5.92 |
| Hardness change | −6 | −5 | −4 | 0 |
| Tensile strength, psi | 1389 | 1570 | 1469 | 1389 |
| Elongation, % | 150.0 | 159.6 | 152.2 | 154.3 |
| Modulus @ 100% elongation | 683 | 703 | 706 | 729 |

This example shows that the A-1 acid scavenger of Example 4 of this invention as illustrated by Fluid 2 and Fluid 4 produced less EPR seal swell at same treat rate than Fluid 1 and Fluid 3 containing the B-1 acid scavenger of Example 4. Unexpectedly, increasing the amount of A-1 in the fluid composition reduced the EPR seal swell. The hardness change is also improved.

What is claimed is:

1. A method for reducing EPR seal swelling in hydraulic systems containing EPR seals that are in contact with phosphate ester hydraulic fluids, the method comprising adding to the fluids an acid scavenger having the formula 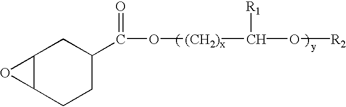
where R₁ is H or a C₁ to C₄ alkyl; x is an integer of 1 to 2; y is an integer of 1 to 4; and R₂ is a C₁ to C₄ alkyl group or a phenyl group;
the acid scavenger being added in an amount sufficient to reduce EPR seal swelling.

2. The method of claim 1 wherein the amount is greater than that required for 100% epoxide.

3. The method of claim 2 wherein R₁ is H; R₂ is C₂H₅, x is 1 and y is 2.

4. In a hydraulic fluid having an organic ester basestock containing a mono-epoxide acid scavenger, the improvement comprising using as the acid scavenger a mono-epoxide having the formula: 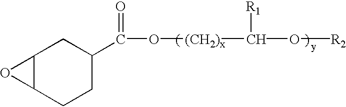
where R₁ is H or a C₁ to C₄ alkyl; x is an integer of 1 to 2; y is an integer of 1 to 4; and R₂ is a C₁ to C₄ alkyl group or a phenyl group.

5. The improvement of claim 4 wherein the acid scavenger is present in an amount form about 1 wt % to about 10.0 wt % based on the weight of the base stock.

6. The improvement of claim 5 wherein R₁ is H, R₂ is —C₂H₅, x is 1 and y is 2.

7. A hydraulic fluid comprising:
(A) a major amount of phosphate ester base fluids, said base fluid comprising:
(i) from about 10 wt % to about 100 wt % of one or more trialkyl phosphate esters;
(ii) from about 0 wt % to about 75 wt % of one or more dialkyl aryl phosphates;
(iii) from about 0 wt % to about 30 wt % of one or more alkyl diaryl phosphates;
(iv) from about 0 wt % to about 20 wt % of one or more triaryl phosphates;
(v) from about 0 wt % to about 20 wt % of one or more alkylated triaryl phosphates
wherein the alkyl groups of (i), (ii) and (iii) have from 3 to 8 carbon atoms and the alkyl groups of (v) have 3 to 4 carbon atoms; and
(B) from about 1 wt % to about 10 wt %, based on the weight of the base fluid, of an acid scavenger having the formula: 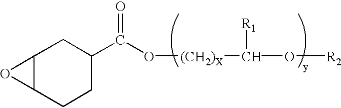
where R₁ is H or C₁ to C₄ alkyl; x is an integer of 1 to 2; y is an integer of 1 to 4; and R₂ is a C₁ to C₄ alkyl group or a phenyl group.

8. The composition of claim 1 wherein the base fluid (A) comprises:
(i) from 20 wt % to 90 wt % of one or more trialkyl phosphates; (ii) from 10 wt % to 15 wt % of triaryl phosphate wherein the aryl group is phenyl; and in the acid scavenger (B) R₁ is H; x is 1; y is 2 and R₂ is ethyl.

9. A compound having the formula 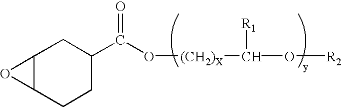
where R₁ is H or C₁ to C₄ alkyl; x is an integer of 1 to 2; y is an integer of 2 or more and R₂ is a C₁ to C₄ alkyl group or a phenyl group.

10. The compound of claim 9 wherein R₁ is H, x is 1, y is 2, and R₂ is a C₂ alkyl group.
